(19) United States
(12) Patent Application Publication
(10) Pub. No.: US 2026/0010436 A1
(43) Pub. Date: Jan. 8, 2026

(54) SYSTEMS AND METHODS FOR BLOCKCHAIN BACKUP AND RESTORATION

(71) Applicant: Verizon Patent and Licensing Inc., Basking Ridge, NJ (US)

(72) Inventors: Ahmed A. Khan, Plano, TX (US); Ravi G. Thota, Hyderabad (IN); Rangesh Sripathi, Chennai (IN); Jeaha Yang, Darien, CT (US); Mohammed Alsadi, Redmond, WA (US)

(73) Assignee: Verizon Patent and Licensing Inc., Basking Ridge, NJ (US)

(21) Appl. No.: 18/765,538

(22) Filed: Jul. 8, 2024

(51) Int. Cl. G06F 11/14

(52) U.S. Cl. CPC G06F 11/1464; G06F 11/1435

(57) ABSTRACT

A system described herein may maintain a set of backup parameters associated with a blockchain. The set of backup parameters may be associated with a first time, and may include first node configuration information of one or more nodes that maintain the blockchain, and first blockchain state information. The system may identify, at a second time, that the blockchain should be restored using the set of backup parameters associated with the first time, and may output, to the blockchain network, a restoration instruction that indicates the set of backup parameters associated with the first time. The blockchain network may replace second node configuration information of the one or more nodes, associated with the second time, with the first node configuration information associated with the first time, and may replace second blockchain state information, associated with the second time, with the first blockchain state information associated with the first time.

### BACKGROUND

Blockchains provide for the decentralized and secure storage of data, decentralized computing, or other technical operations. Blockchains may further provide for the immutability of recorded data (e.g., as maintained by computing devices that implement nodes), as data may not be altered once recorded to a blockchain. Blockchains may be maintained by multiple nodes, such as geographically distributed or otherwise distinct servers, workstations, etc., that each maintain local copies of respective blockchains, perform computing operations based on information (e.g., executable code, instructions, variables, etc.) recorded to respective blockchains, and/or perform other operations.

### BRIEF DESCRIPTION OF THE DRAWINGS

FIG. 1 illustrates an example overview of obtaining blockchain backup parameters, in accordance with some embodiments;

FIGS. 2A and 2B illustrate examples of communicating with a blockchain network in order to perform backup and/or restoration operations, in accordance with some embodiments;

FIG. 3 illustrates an example of maintaining multiple sets of backup parameters, in accordance with some embodiments;

FIGS. 4-6 illustrate example blockchain restoration operations, in accordance with some embodiments;

FIGS. 7A and 7B illustrate example operations associated with recording information to a blockchain, in accordance with some embodiments;

FIG. 8 illustrates an example process for implementing a blockchain backup and restoration, in accordance with some embodiments;

FIG. 9 illustrates an example environment in which one or more embodiments, described herein, may be implemented; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Blockchains may be maintained by multiple nodes, such as geographically distributed or otherwise distinct servers, workstations, etc., that each maintain local copies of respective blockchains. A blockchain network may refer to a particular group of nodes that communicate with each other to maintain a particular blockchain. For example, the nodes may maintain local copies of the blockchain and changes to the blockchain may be subject to satisfying a consensus mechanism implemented by the blockchain network. The consensus mechanism may aid in avoiding unauthorized changes from being made to the blockchain, thus providing a measure of immutability to the blockchain.

Situations may arise in which blockchain should be restored, or “rolled back,” to an earlier version, which may include removing records from the blockchain that have been added after a particular time. Such situations may occur, for example, when the blockchain is subject to an attack, error (e.g., accidental or unintended recordation of information to the blockchain), unauthorized access, or other similar scenario. Rolling back the blockchain to a point in time prior to the attack, error, etc. may alleviate or eliminate any harm that would have otherwise arisen from such attack, error, etc. However, as noted above, the immutability of blockchains (e.g., based on consensus mechanisms implemented by blockchain networks) may pose challenges to performing such restoration (e.g., “rollback”) operations. Further, changes to configurations of nodes of blockchain networks (e.g., different versions of application programming interfaces (“APIs”), software development kits (“SDKs”), blockchain frameworks, etc.) that occur over time may be incompatible with earlier versions of a blockchain maintained by the nodes. For example, a newer version of a blockchain framework, implemented by a particular node, may reference particular information recorded to the blockchain at a given time. Rolling back the blockchain to an earlier time may interfere with or render inoperable the newer version of the API, because the rollback may include removing the information from the blockchain to which the API refers.

Further, a modification to the blockchain by one node (e.g., a proposed deletion of information that has been previously recorded to the blockchain) may be rejected, discarded, etc. by way of the consensus mechanism. For example, other nodes of the blockchain network may reject a version of the blockchain that does not match copies of the blockchain that is locally maintained by the other nodes.

Systems described herein provide for the restoration (e.g., rollback) of blockchains to an earlier state. For example, as discussed below, the restoration of a blockchain may include removing records from the blockchain (e.g., records that have been recorded to the blockchain after a certain point in time, after a specific block height, etc.). As also discussed below, the restoration may be performed in a decentralized manner, such that nodes of a blockchain network are able to validate a rollback prior to implementing the rollback, thus avoiding potential unauthorized rollback operations. Additionally, the restoration operations may include rolling back node configuration information (e.g., APIs, SDKs, blockchain frameworks, authentication keys, certificates, etc.), thus avoiding situations in which nodes attempt to perform operations that reference blockchain information that has been deleted based on performing the restoration operations.

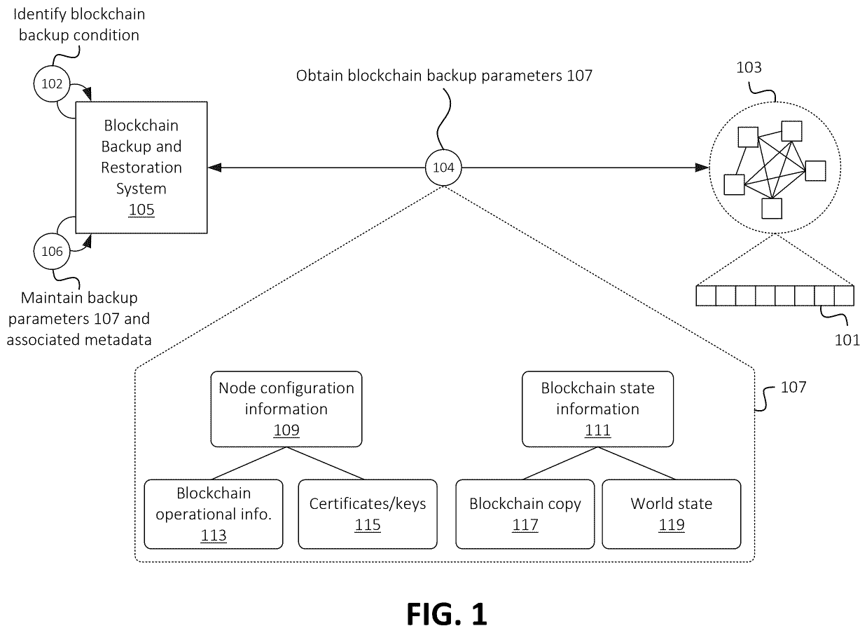

As shown in FIG. 1, a particular blockchain 101 may be maintained by a group of nodes (i.e., blockchain network 103). The nodes may implement a set of APIs, SDKs, a blockchain framework, etc. via which the nodes communicate with each other to maintain blockchain 101. For example, each node may maintain a respective local copy of blockchain 101, may maintain world state information derived from blockchain 101 (e.g., values, variables, etc. that are recorded to blockchain 101), may initiate or participate in consensus mechanisms to validate the addition of new information to blockchain 101, etc.

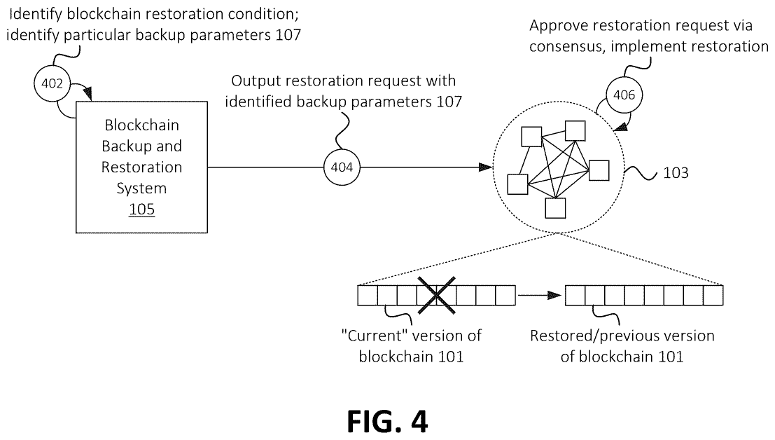

Blockchain Backup and Restoration System (“BBRS”) 105 may perform operations related to backing up and restoring blockchain 101, as discussed herein. FIGS. 1-3 illustrate example backup operations with respect to a particular blockchain 101, and FIGS. 4-6 illustrate example restoration operations with respect to blockchain 101. BBRS 105 may be communicatively coupled to one or more nodes of blockchain network 103, such that BBRS 105 is able to access blockchain 101 (e.g., access some or all information recorded to blockchain 101), and is further able to communicate with blockchain network 103 in order to perform the backup and restoration operations described herein.

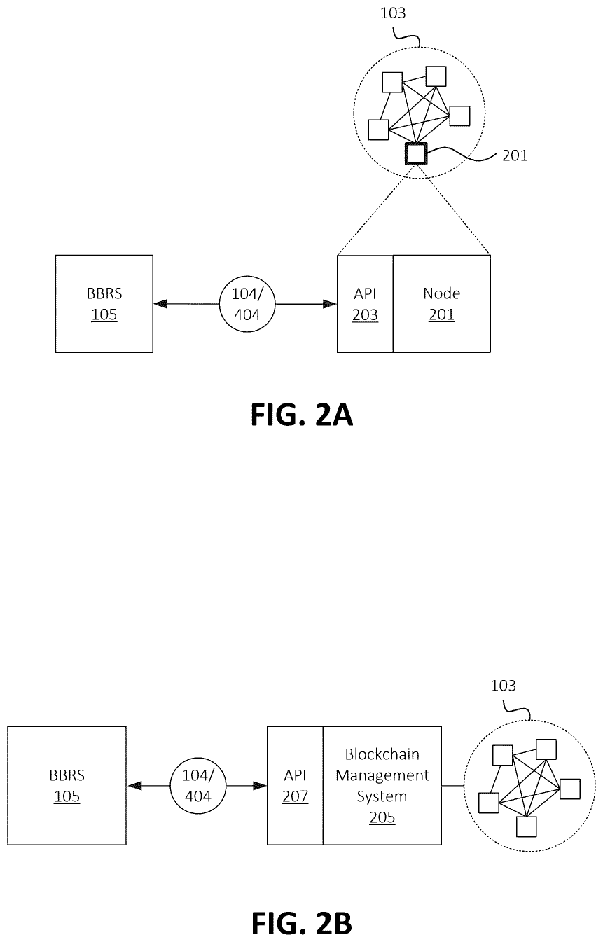

In some embodiments, as shown in FIG. 2A, for example, BBRS 105 may be communicatively coupled to one or more particular nodes 201 of blockchain network 103 via API 203. For example, one or more nodes 201 may implement API 203, an application, an SDK, or some other suitable mechanism by which BBRS 105 is able to communicate with node 201. In some embodiments, API 203 may facilitate authentication and/or authorization techniques, whereby node 201 is able to verify that BBRS 105 is authorized to perform the operations discussed herein (e.g., prevent unauthorized access).

In some embodiments, as shown in FIG. 2B, blockchain network 103 may be associated with Blockchain Management System (“BMS”) 205, which may manage, configure, provision, etc. nodes of blockchain network 103. In some embodiments, BMS 205 may implement or may otherwise be associated with a blockchain framework such as the Hyperledger® Fabric. BMS 205 may designate or otherwise maintain information specifying particular roles or types for each node, such as ordering nodes, peer nodes, certificate authority (“CA”) nodes, etc. As another example, BMS 205 may manage access to blockchain 101 maintained by blockchain network 103 (e.g., blockchain 101 may be a “permissioned” blockchain), where managing such access includes maintaining information indicating that BBRS 105 is authorized to access blockchain 101 (e.g., to perform backup and/or restoration operations, to obtain some or all of the information maintained on blockchain 101, etc.). In some embodiments, BMS 205 may implement API 207, via which BBRS 105 may securely access blockchain 101 and/or other suitable information associated with blockchain network 103 in order to perform the backup and/or restoration operations described herein.

Returning to FIG. 1, BBRS 105 may determine (at 102) a blockchain backup condition (e.g., a condition that, when satisfied, indicates that a backup should be performed with respect to blockchain 101). For example, BBRS 105 may receive a request (e.g., via an API, a web portal, an application, or some other suitable communication pathway) from a user, an application, etc. to back up blockchain 101.

As another example, BBRS 105 may determine (at 102) the blockchain backup condition based on identifying an update, upgrade, or other modification to an API, an SDK, a blockchain framework, configuration information, authentication information (e.g., authentication keys, certificates, etc.), or other information or attributes associated with one or more nodes of blockchain network 103. For example, as discussed above, BBRS 105 may communicate with one or more nodes 201 of blockchain network 103 (e.g., via API 203) and/or with BMS 205 (e.g., via API 207) to identify the update, upgrade, modification, etc. Node 201 and/or BMS 205 may “push” a notification to BBRS 105 indicating the update, upgrade, modification, etc. As another example, BBRS 105 may periodically or intermittently query node 201 and/or BMS 205 for current version information associated with an API, an SDK, a blockchain framework, etc. implemented by nodes 201 of blockchain network 103, and may compare such version information with previously received version information in order to determine whether an update has occurred.

As another example, BBRS 105 may determine (at 102) the blockchain backup condition based on temporal conditions, such as an hourly or daily backup at certain times. In some embodiments, the temporal condition may include determining that an age of a last backup has exceeded a threshold (e.g., if the last backup occurred 24 hours ago, BBRS 105 may determine that a new backup should be created). As yet another example, BBRS 105 may determine (at 102) the backup condition based on block height (e.g., a quantity of records that have been recorded to blockchain 101). For example, BBRS 105 may identify that a backup of blockchain 101 should be created every 10 blocks, every 100 blocks, etc. Additionally, or alternatively, BBRS 105 may identify that if a backup has not been created since the most recent 10 blocks, 100 blocks, etc. have been added to blockchain 101, then a backup should be created. As yet another example, BBRS 105 may determine (at 102) the backup condition based on size of blockchain 101 (e.g., an amount of data, such as kilobytes, megabytes, etc. of one or more files that are used by nodes 201 to maintain blockchain 101). For example, BBRS 105 may determine that a backup should be created every 10 megabytes, every 100 megabytes, etc.

Based on identifying (at 102) the blockchain backup condition, BBRS 105 may proceed to create the backup of blockchain 101. Creating the backup may include communicating (at 104) with blockchain network 103 (e.g., with one or more nodes 201 of blockchain network 103 and/or with BMS 205, as discussed above with respect to FIGS. 2A and 2B) in order to obtain a set of blockchain backup parameters 107. BBRS 105 may accordingly maintain (at 106) one or more sets of blockchain backup parameters 107 (e.g., associated with different times, different block heights, etc.).

In some embodiments, blockchain backup parameters 107 may include node configuration information 109 and blockchain state information 111. In some embodiments, blockchain backup parameters 107 may include additional and/or different information. Node configuration information 109 may include blockchain operational information 113, which may include information used by nodes of blockchain network 103 (e.g., one or more nodes 201) to perform blockchain operations. Blockchain operational information 113 may specify, may include, etc. instructions or other suitable information related to performing blockchain operations such as maintaining blockchain 101, participating in consensus mechanisms with respect to blockchain 101, executing operations based on information recorded to blockchain 101 (e.g., chaincode that specifies one or more operations to perform on a set of inputs in order to generate a set of outputs), or the like.

In some embodiments, blockchain operational information 113 may include, may implement, may be implemented by, and/or may otherwise be associated with one or more APIs, SDKs, frameworks, etc. In some embodiments, such APIs, SDKs, etc. may be associated with executable code, installation packages, etc. that are installed at or are otherwise used by nodes of blockchain network 103 to implement blockchain operations with respect to blockchain 101. Such executable code, installation packages, etc. may be associated with respective versions. In this manner, updates to the executable code, installation packages, etc. may be identifiable on the basis of such version information. As discussed above, blockchain operational information 113 (e.g., chaincode) maintained by nodes of blockchain network 103 may include references to information (e.g., blocks) recorded to blockchain 101. The referenced information may include, for example, a set of inputs, a set of operations to perform based on the set of inputs, and/or a set of outputs that were generated based on performing the operations on the inputs.

Blockchain operational information 113 may also include information specifying consensus protocols implemented by blockchain network 103. For example, such consensus protocol information may indicate thresholds such as a minimum quantity or proportion of nodes from which a positive consensus indication is required in order to be considered as a consensus being reached by blockchain network 103. As another example, blockchain operational information 113 may include communication protocol information, specifying one or more types of messages or communications between nodes of blockchain network 103 that may be used by such nodes in order to communicate with each other.

In some embodiments, blockchain operational information 113 may include additional or different types of information specifying operations to perform with respect to blockchain 101. In some embodiments, as discussed below, different types of nodes may be associated with different sets of blockchain operational information 113. For example, a first type of node (e.g., an ordering node) may be associated with a first set of blockchain operational information 113, which includes information based on which the first node may perform ordering operations (discussed in more detail below) with respect to blockchain 101. On the other hand, a second type of node (e.g., a peer node) may be associated with a second set of blockchain operational information 113, which includes information based on which the second node may perform peer operations (discussed in more detail below) with respect to blockchain 101.

Node configuration information 109 may also, in some embodiments, include certificates and/or keys 115. Certificates and/or keys 115 may include certificates, keys, etc. relating to security and/or authentication mechanisms implemented by blockchain network 103, such as Transport Layer Security (“TLS”) certificates, CA certificates, public and/or private keys, and/or other suitable security and/or authentication information. In some situations, node configuration information 109 may be updated, modified, etc. over time. As such, maintaining node configuration information 109 as part of blockchain backup parameters 107 may aid in restoring prior versions of certificates and/or keys 115 in suitable situations, as discussed below.

Blockchain state information 111 may, in some embodiments, include a copy of blockchain 101 (i.e., blockchain copy 117), as maintained by nodes of blockchain network 103. Blockchain copy 117 may include, for example, a full copy of blockchain 101. In some embodiments, blockchain state information 111 may include a partial copy of blockchain 101 in addition to or in lieu of a full blockchain copy 117, such as a first block of blockchain 101 (e.g., a “genesis” block), a particular quantity of most recent blocks of blockchain 101, etc.

In some embodiments, blockchain state information 111 may include world state information 119 associated with blockchain 101. World state information 119 may include, for example, “current” or most recent values of particular variables, parameters, etc. recorded to blockchain 101. For example, if multiple values are recorded to blockchain 101, where such multiple values are associated with the same variable, the world state information may reflect the most recent value for such variable. In some embodiments, world state information 119 may include partial or full history information for such variables.

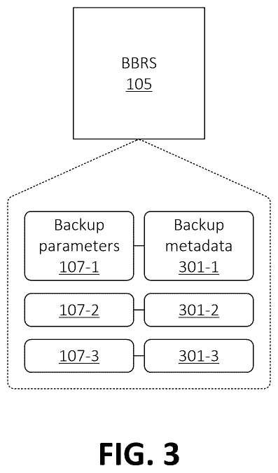

As shown in FIG. 3, BBRS 105 may perform multiple iterations of obtaining (at 104) blockchain backup parameters 107, in order to obtain multiple sets of blockchain backup parameters 107 with respect to blockchain 101 and/or blockchain network 103. For example, as discussed above, BBRS 105 may obtain (at 104) such blockchain backup parameters 107 periodically, based on user requests, based on identifying operational updates to nodes of blockchain network 103, etc.

Blockchain backup parameters 107-1 may, for example, be associated with or may be denoted by a first time (e.g., a first timestamp), a first block height (e.g., a height of blockchain 101 when blockchain backup parameters 107-1 were generated or received), or other information based on which a “cutoff” with respect to blockchain 101 may be determined. Similarly, blockchain backup parameters 107-2 may be associated with or may be denoted by a second time or block height, and blockchain backup parameters 107-3 may be associated with a third time or block height. In some embodiments, blockchain backup parameters 107 may each be associated with a respective set of backup metadata 301. For example, blockchain backup parameters 107-1 may be associated with backup metadata 301-1, blockchain backup parameters 107-2 may be associated with backup metadata 301-2, and blockchain backup parameters 107-3 may be associated with backup metadata 301-3. Backup metadata 301 may, for example, include a cryptographic hash of blockchain 101 as of a time, block height, etc. associated with a particular set of blockchain backup parameters 107. In some embodiments, a particular set of backup metadata 301 may include information indicating a size of blockchain 101 (e.g., in terms of kilobytes, megabytes, gigabytes, etc.), a quantity of blocks or records recorded to blockchain 101 (e.g., a “block height” of blockchain 101), a date or time at which blockchain backup parameters 107 were generated or received, or other suitable information that is derived from or is otherwise associated with blockchain 101 as of a time, block height, etc. associated with blockchain backup parameters 107.

As noted above, a particular set of blockchain backup parameters 107 may include different sets of node configuration information 109 for different types or roles of nodes. For example, blockchain backup parameters 107-1 may include a first set of node configuration information 109 for ordering nodes, a second set of node configuration information 109 for peer nodes, and a third set of node configuration information 109 for CA nodes. Similarly, blockchain backup parameters 107-2 may include a fourth set of node configuration information 109 for ordering nodes, a fifth set of node configuration information 109 for peer nodes, a sixth set of node configuration information 109 for CA nodes, and so on.

FIG. 4 illustrates an example of restoring blockchain 101 to a previous state (e.g., based on a particular set of blockchain backup parameters 107). As shown, BBRS 105 may identify (at 402) a blockchain restoration condition. In some embodiments, the blockchain restoration condition may include or may be associated with a request from a user, an application, etc. (e.g., via a user interface, an API, etc.) to restore (e.g., roll back) blockchain 101 to a given state. The request may include a particular time, block height, etc. to which blockchain 101 should be restored.

As one example, assume that the restoration request is received at 9:00 AM on January 2, and the request indicates that blockchain 101 should be restored to its state as of 12:00 AM on January 1 (e.g., a rollback of 31 hours). As another example, assume that the restoration request is received when a current block height is 100,000, and the request indicates that blockchain 101 should be restored to its state as of the 900,000th block (e.g., a rollback of 100,000 blocks).

In some embodiments, BBRS 105 may identify (at 402) the blockchain restoration condition based on identifying that particular criteria is satisfied or that one or more particular events or types of events have occurred. For example, in some embodiments, BBRS 105 may identify the blockchain restoration condition based on on-chain information (e.g., may identify anomalous or malicious information recorded to blockchain 101) and/or based on off-chain information or events (e.g., events or conditions that occur independently of blockchain 101).

BBRS 105 may output (at 404) a restoration request to blockchain network 103 (e.g., to one or more nodes 201 and/or to BMS 205 via API 203 or API 207, respectively). In some embodiments, the restoration request may include some or all of a particular set of blockchain backup parameters 107 and/or an associated set of backup metadata 301. In some embodiments, the restoration request may include a link, a Uniform Resource Locator (“URL”), or some other reference based on which some or all of blockchain backup parameters 107 may be obtained. For example, in some embodiments, BBRS 105 or some other device or system may store, maintain, host, etc. one or more sets of blockchain backup parameters 107 (e.g., which may include respective sets of node configuration information 109 and/or blockchain state information 111, as discussed above), and such blockchain backup parameters 107 may be obtainable via the link, URL, etc.

Nodes of blockchain network 103 may communicate with each other in order to reach a consensus as to whether to approve or deny the restoration request. For example, the nodes may verify authorization or authentication of BBRS 105, may verify whether the restoration request satisfies policies or permissions with respect to performing the restoration (e.g., a policy that restricts rollbacks to versions of blockchain 101 that are too old or some other suitable policy), and/or may otherwise determine whether to perform the requested restoration. In this example, assume that nodes of blockchain network 103 approve (at 406) the restoration request. Blockchain network 103 may proceed to implement the restoration, which may include rolling back a “current” version of blockchain 101 to a previous version (e.g., a version identified based on the restoration request). As noted above, rolling back blockchain 101 may include removing information, from blockchain 101, that has been recorded after the time, block height, etc. specified in the restoration request.

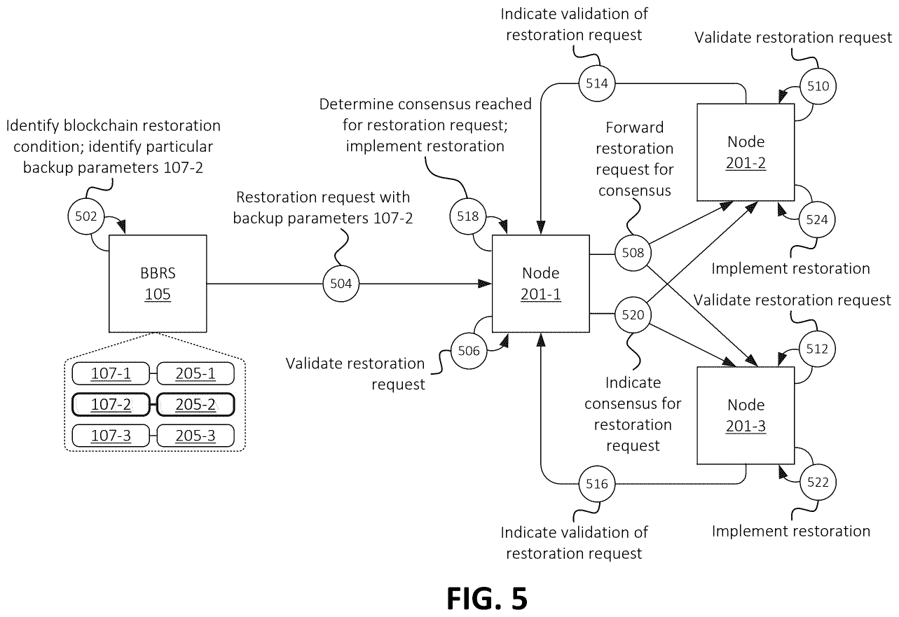

Implementing the restoration may further include rolling back or otherwise modifying other information, parameters, etc., such as blockchain operational information 113, certificates and/or keys 115, and/or other suitable information. FIG. 5 illustrates an example of implementing a particular set of blockchain backup parameters 107. As shown, BBRS 105 may identify (at 502) a blockchain restoration condition and may identify a particular set of blockchain backup parameters 107 (e.g., blockchain backup parameters 107-2, out of a set of candidate set of blockchain backup parameters 107 that include blockchain backup parameters 107-1, 107-2, and 107-3). For example, BBRS 105 may identify that a request specifies a particular block height, and that blockchain backup parameters 107-2 match the requested block height. In some embodiments, identifying the “match” may include identifying that a block height or time associated with blockchain backup parameters 107-2 are closest (e.g., closer than blockchain backup parameters 107-1 and 107-3) to, without exceeding or being later than, a requested block height or time. In some embodiments, identifying the “match” may include identifying that a block height or time associated with blockchain backup parameters 107-2 are closest to, without being less than or earlier than, a requested block height or time.

BBRS 105 may accordingly output (at 504) a restoration request, indicating blockchain backup parameters 107-2, to a particular node 201-1 of blockchain network 103 (or, as discussed above, BMS 205 of blockchain network 103, which may ultimately forward some or all of the request to node 201-1). As discussed above, the request may include blockchain backup parameters 107-2, and/or may include a link, URL, reference, etc. to some or all of blockchain backup parameters 107-2. Node 201-1 may validate (at 506) the restoration request, which may include authenticating BBRS 105, verifying that BBRS 105 is authorized to make the request, verifying that the restoration request does not violate one or more policies, etc. In this example, assume that node 201-1 validates the restoration request (e.g., determines that the restoration request should be granted). Node 201-1 may accordingly forward (at 508) the request to one or more other nodes of blockchain network 103, such as nodes 201-2 and 201-3. For example, node 201-1 may broadcast the request to all nodes of blockchain network 103, and/or may otherwise select particular nodes 201-2 and 201-3 to participate in a consensus mechanism by which the restoration request may be approved or denied.

As similarly discussed above with respect to node 201-1, nodes 201-2 and 201-3 may validate (at 510 and 512, respectively) the restoration request. For example, nodes 201-2 and 201-3 may determine whether to grant the restoration request, as similarly discussed above. Assuming that nodes 201-2 and 201-3 validate (e.g., approve) the restoration request, nodes 201-2 and 201-3 may indicate (at 514 and 516, respectively) that the restoration request is granted. Node 201-1 may determine (at 518) that consensus has been reached with respect to the restoration request. For example, in accordance with a restoration consensus policy, maintained by node 201-1 and associated with validating or approving restoration requests, node 201-1 may determine that at least a threshold quantity or proportion of nodes of blockchain network 103 (e.g., a majority consensus, a unanimous consensus, etc.) have validated the restoration request.

Node 201-1 may accordingly implement (at 518) the requested restoration with respect to blockchain 101. Additionally, node 201-1 may output (at 520), broadcast, etc. an indication to the nodes of blockchain network 103 (e.g., nodes 201-2 and 201-3 in this example), indicating that the restoration request has been approved by blockchain network 103 (e.g., based on the restoration consensus mechanism). Nodes 201-2 and 201-3 may also implement (at 522 and 524) the restoration. As discussed above, implementing the restoration (e.g., at 518, 522, and 524) may include rolling back local copies of blockchain 101, as maintained by nodes 201-1 through 201-3, to a version of blockchain 101 (e.g., as indicated by a particular blockchain copy 117 associated with blockchain backup parameters 107-2). Implementing the restoration may also include rolling back APIs, SDKs, chaincode, framework versions, etc. to versions indicated in blockchain backup parameters 107-2. In some embodiments, implementing the restoration may also include rolling back world state information to reflect the rolled back blockchain 101. As additionally discussed above, implementing the restoration may further include rolling back certificates, keys, etc. to an earlier version indicated in blockchain backup parameters 107-2. As noted above, blockchain backup parameters 107-2 may be provided (e.g., by BBRS 105) as part of the request, or may be obtained by individual nodes 201 via a link, URL, etc.

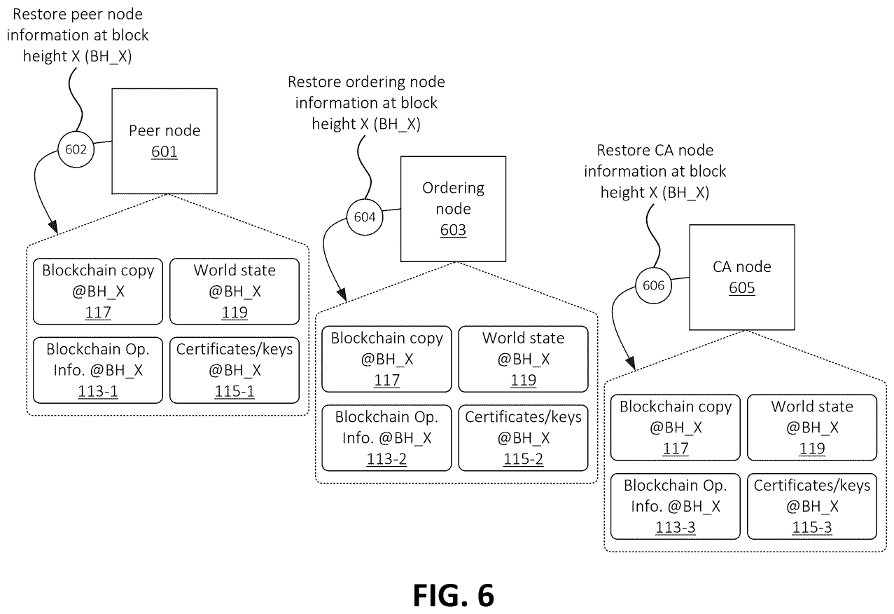

As additionally noted above, blockchain backup parameters 107 may include different types of parameters or information for different types, roles, etc. of nodes. For example, as shown in FIG. 6, when implementing a restoration, one or more peer nodes 601 of blockchain network 103 may restore (at 602) peer node information included in blockchain backup parameters 107 as of particular block height (represented as “BH_X”) of blockchain 101 (e.g., may rollback updates, configurations, blockchain information, etc. performed or implemented after BH_X). For example, the peer node information may include blockchain operational information 113-1, which may specify operations, instructions, parameters, etc. associated with performing blockchain operations for peer node 601 (e.g., validating blocks to be added to blockchain 101, participating in consensus mechanisms, executing chaincode, etc.). Peer node 601 may also restore a set of certificates and/or keys 115-1 that are associated with peer nodes 601 of blockchain network 103 (e.g., which may be different from certificates and/or keys maintained by other types of nodes of blockchain network 103). Peer node 601 may also restore (at 602) blockchain state information 111, such as a particular blockchain copy 117, world state information 119, etc., as discussed above.

Similarly, ordering node 603 may restore (at 604) information associated with ordering node operations (e.g., blockchain operational information 113-2 and certificates and/or keys 115-2), as included in blockchain backup parameters 107, and CA node 605 may restore (at 606) information associated with CA node operations (e.g., blockchain operational information 113-3 and certificates and/or keys 115-3). In some embodiments, ordering nodes 603 and CA nodes 605 of blockchain network 103 may also maintain, restore, etc. blockchain copy 117 and world state information 119. In some embodiments, one or more ordering nodes 603 and/or CA nodes 605 may not maintain blockchain copy 117 and/or world state information 119, and thus may not perform restoration operations with respect to such information (e.g., may roll back only respective blockchain operational information 113 and/or certificates and/or keys 115).

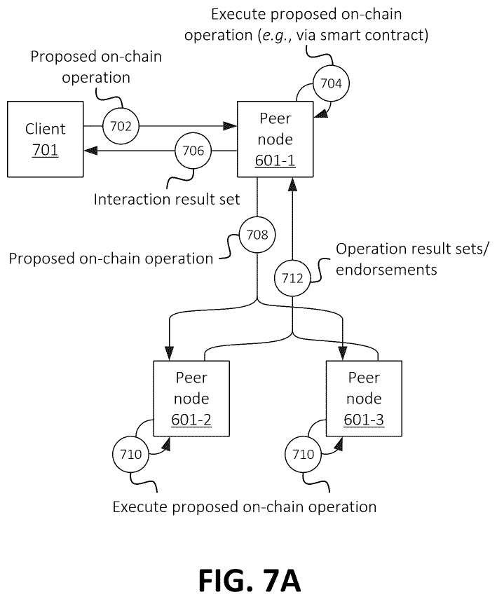

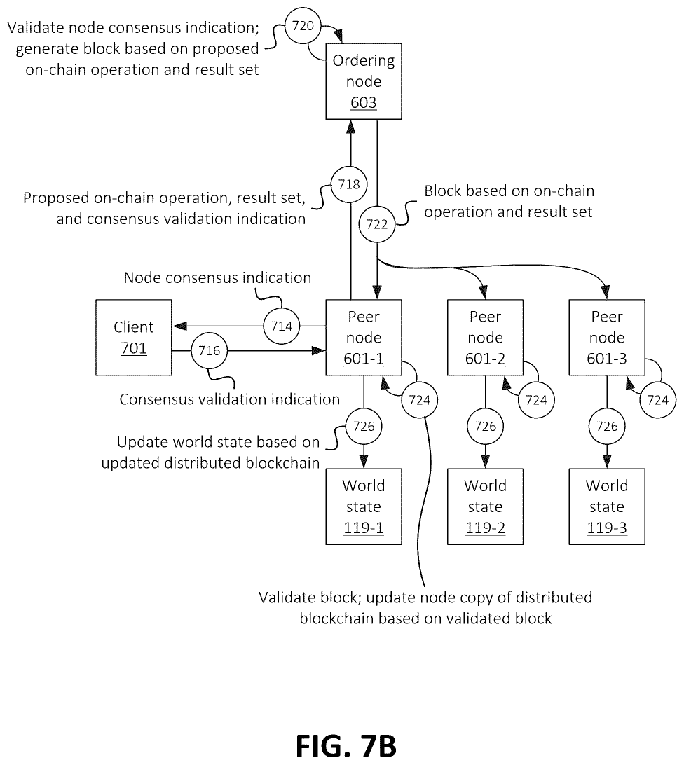

FIGS. 7A and 7B illustrate an example of modifying blockchain 101 and/or world state information based on an interaction with blockchain 101. As shown, a particular peer node 601-1 may receive (at 702) a proposed on-chain operation (e.g., a request to access or record information to blockchain 101) from a particular source, such as client 701 (e.g., which may be or may be implemented by a device or system that has access to peer node 601-1, such as a device or system that has authentication credentials, locator information, etc. via which client 701 is able to interact with peer node 601-1). In some embodiments, peer node 601-1 may receive the proposed on-chain operation from a blockchain management system (e.g., which may receive the proposed on-chain operation from client 701 and may select peer node 601-1 out of a group of peer nodes 601, such as a group of nodes associated with the same channel in a channel-based blockchain system, such as the Hyperledger® Fabric), an ordering node, or other suitable device or system.

Client 701 may be, for example, an entity associated with blockchain 101 (e.g., may be associated with an address, a “wallet,” a decentralized application (“dApp”), etc.). In this example, assume that client 701 is authorized to initiate, request, etc. the proposed on-chain operation, which may include the modification of one or more values of one or more attributes that are currently associated with blockchain 101, the addition of one or more attributes to blockchain 101, or other suitable interactions. In other examples, peer node 601-1 and/or some other device or system may verify that client 701 is authorized to initiate the proposed on-chain operation.

In some embodiments, the proposed on-chain operation (received at 702) may indicate or refer to chaincode recorded to blockchain 101, which may specify one or more inputs (e.g., types of inputs, quantity of inputs, and/or other input parameters), and may also include actions to take with respect to the inputs in order to generate one or more outputs (e.g., chaincode). For example, the proposed on-chain operation may specify particular chaincode (e.g., an address or reference associated with blockchain 101 that includes a record with which the chaincode is associated) and one or more input values according to input parameters specified by the particular chaincode. In some examples, the proposed on-chain operation may refer to one or more values that have previously been recorded to blockchain 101 (and thus reflected in world state information associated with blockchain 101), such as an interaction that increments or decrements previously recorded values or performs other computations based on previously recorded values.

Peer node 601-1 may execute (at 704) the proposed on-chain operation, which may include accessing the one or more values that were previously recorded to blockchain 101. In order to determine the one or more values referred to in the proposed on-chain operation, peer node 601-1 may access world state information, maintained by peer node 601-1, to determine such values. Such access may include checking a local cache and/or accessing, via a network, a remote system (e.g., a “cloud” system, a containerized system, etc.) associated with peer node 601-1 that maintains the world state associated with blockchain 101. The execution (at 704) may be a “simulation” of the proposed on-chain operation, inasmuch as the execution and of the proposed on-chain operation and the ensuing result may not yet be recorded to blockchain 101. The interaction may become “final” or “committed” based on validation by one or more other nodes. The result may include a “read-write set,” which may include the values of the one or more attributes that were accessed (e.g., the values based on which the interaction was performed), as well as the resulting values after execution of the proposed interaction.

Peer node 601-1 may provide (at 706) the result set (e.g., the read-write set) based on executing (at 704) the proposed interaction to client 701. Client 701 may maintain the result set to, for example, verify and/or to provide approval of the result set before the result set is committed to blockchain 101. Peer node 601-1 may also provide (at 708) the proposed on-chain operation to one or more other peer nodes 601 associated with blockchain 101, such as peer nodes 601-2 and 601-3. In some embodiments, peer node 601-1 may provide (at 708) the result set generated by peer node 601-1 to peer nodes 601-2 and 601-3. Peer nodes 601-1 through 601-3 may all be associated with the same channel, peer nodes 601-2 and 601-3 may be specified by the chaincode as validators, and/or peer nodes 601-2 and 601-3 may otherwise be identified by peer node 601-1 or an associated blockchain management system as nodes that should validate, endorse, etc. the execution and result of the proposed interaction.

As similarly discussed with respect to peer node 601-1, peer nodes 601-2 and 601-3 may execute (at 710), and/or simulate the execution of, the proposed interaction. Accordingly, peer nodes 601-2 and 601-3 may access one or more values that were previously recorded to blockchain 101 using world state information maintained by peer nodes 601-2 and 601-3. Peer nodes 601-2 and 601-3 may validate, verify, etc. the result set generated by peer node 601-1 by comparing the result set with respective result sets generated by peer nodes 601-2 and 601-3. Peer nodes 601-2 and 601-3 may respond (at 712) to peer node 601-1 with respective result sets generated by peer nodes 601-2 and 601-3, and/or may respond with an indication, endorsement, etc. (e.g., which may be respectively signed by peer nodes 601-2 and 601-3) that the result set generated by peer node 601-1 is valid. Once peer node 601-1 has received endorsements from at least a threshold quantity of other nodes (e.g., from peer nodes 601-2 and 601-3, in this example), peer node 601-1 may determine that a consensus has been reached with respect to the result set for the proposed interaction.

As shown in FIG. 7B, peer node 601-1 may accordingly provide (at 714), to client 701, an indication that consensus for the result set (provided at 706) has been reached. In some embodiments, client 701 may validate the consensus (e.g., by evaluating signatures of peer nodes 601-2 and 601-3) and/or may verify the result set (e.g., by itself executing the proposed interaction). Client 701 may provide (at 716), to peer node 601-1, an indication that client 701 has validated the consensus and/or has verified the result set. In some embodiments, the consensus validation indication may be signed by client 701, thus securely authenticating the validation by client 701.

Peer node 601-1 may provide (at 718) the result set, along with the consensus validation indication and the proposed on-chain operation, to ordering node 603. Ordering node 603 may be a node, associated with the same channel as peer nodes 601-1 through 601-3, that validates (at 720) the consensus validation indication (e.g., validates signatures associated with client 701 and/or peer nodes 601-1 through 601-3) and generates a block, to be recorded to blockchain 101, that includes information regarding the on-chain operation. Such information may include an identifier of client 701 (e.g., an address, wallet identifier, etc.), identifiers of peer nodes 601-1 through 601-3 that participated in generating and/or validating the result set based on the on-chain operation, chaincode inputs provided by client 701, the consensus validation indication, one or more timestamps of the above operations and/or other events, and/or other suitable information associated with the on-chain operation. In some embodiments, the block may be signed by ordering node 603, thus securely authenticating the block creation by ordering node 603. At this point, the on-chain operation may no longer be a “proposed” on-chain operation, as the interaction has been finalized, committed, etc. by ordering node 603. In some implementations, peer nodes 601-1 through 601-3 may be referred to as “peers,” to indicate that such peer nodes 601-1 through 601-3 are distinct from ordering node 603 (e.g., ordering node 603 performs one or more different operations from the peers).

Ordering node 603 may propagate (at 722) the signed block, including information regarding the finalized on-chain operation initiated by client 701, to peer nodes 601-1 through 601-3 and/or other nodes associated with the same channel. Peer nodes 601-1 through 601-3 may validate (at 724) the block, which may include verifying the signature of ordering node 603, and may accordingly update a respective copy of blockchain 101 as maintained by each one of peer nodes 601-1 through 601-3. Peer nodes 601-1 through 601-3 may maintain respective independent copies of blockchain 101, thus providing an element of decentralization to blockchain 101. As such, when adding the block (received at 722), peer nodes 601-1 through 601-3 may continue to maintain separate copies of the same blockchain 101, including the information regarding the finalized on-chain operation.

Peer nodes 601-1 through 601-3 may also maintain respective world state information 119 (e.g., world state information 119-1, 119-2, and 119-3). For example, world state information 119 may include a portion of the information stored in blockchain 101, such as the latest version of some or all of the attributes for which information has been recorded to blockchain 101. Peer nodes 601-1 through 601-3 may accordingly update (at 726) respective copies of world state information 119 based on the received block. For example, in the event that the block includes a change in the value of a particular attribute, peer nodes 601-1 through 601-3 may update world state information 119-1, 119-2, and 119-3, respectively, to replace a previous value of the attribute (e.g., a previous version of the attribute) with the newly received value of the particular attribute.

In some embodiments, the consensus mechanism for validating on-chain operations (e.g., as described above with respect to FIGS. 7A and 7B) may be different, separate, independent, etc. of a consensus mechanism for implementing restoration operations with respect to blockchain 101 (e.g., as discussed above with respect to FIGS. 4 and 5). For example, the consensus mechanism for validating on-chain operations may specify a first threshold based on which a consensus may be identified (e.g., a majority consensus), while the consensus mechanism for validating a requested restoration operation may specify a second threshold based on which a consensus may be identified (e.g., a unanimous consensus).

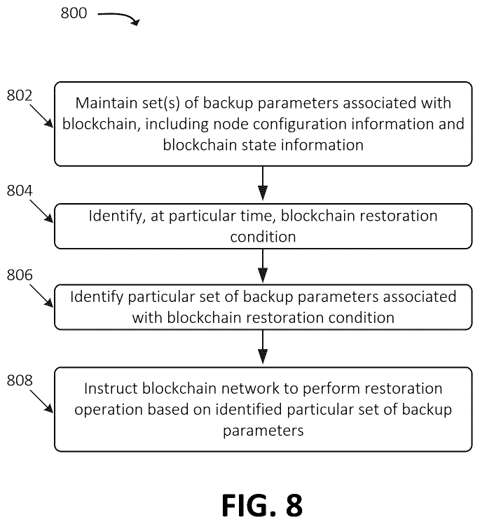

FIG. 8 illustrates an example process 800 for implementing a blockchain backup and restoration, in accordance with some embodiments. In some embodiments, some or all of process 800 may be performed by BBRS 105. In some embodiments, one or more other devices may perform some or all of process 800 in concert with, and/or in lieu of, BBRS 105.

As shown, process 800 may include maintaining (at 802) one or more sets of backup parameters 107 associated with a particular blockchain 101. As discussed above, BBRS 105 may request, obtain, etc. different sets of backup parameters based on different conditions, triggers, etc., such as a periodic backup or an event-based backup (e.g., based on detecting a change to node configuration information or some other type of on-chain or off-chain event).

As also discussed above, the backup parameters may include node configuration information 109 and blockchain state information 111. Node configuration information 109 may include different types of node configuration information for different types or roles of nodes of a blockchain network 103 that includes multiple nodes that maintain blockchain 101.

Node configuration information 109 may, for example, include blockchain operation information 113, certificates and/or keys 115, and/or other suitable configuration information. Blockchain state information 111 may include local copy 117 of blockchain 101, a genesis block of blockchain 101, world state information 119 that is derived from blockchain 101, etc. As discussed above, multiple different sets of backup parameters 107 may be associated with different times, different block heights (e.g., different quantities of records that have been recorded to blockchain 101), or the like. For example, a first set of blockchain backup parameters 107 may be a first “snapshot” associated with a first time or a first block height (e.g., a first quantity of records included in blockchain 101), a second set of blockchain backup parameters 107 may be a second “snapshot” associated with a second time or a second block height (e.g., a second quantity of records included in blockchain 101), and so on.

Process 800 may further include identifying (at 804), at a particular time, a blockchain restoration condition. For example, at some point after the one or more sets of blockchain backup parameters 107 have been received by BBRS 105, BBRS 105 may identify that a particular set of blockchain backup parameters 107 should be used to restore blockchain 101. As discussed above, such condition may occur based on identifying an error condition, a malicious access of blockchain 101, and/or some other suitable on-chain or off-chain event or condition.

Process 800 may additionally include identifying (at 806) a particular set of blockchain backup parameters 107 associated with the blockchain restoration condition. For example, BBRS 105 may select a particular set of blockchain backup parameters 107 (e.g., out of multiple sets of maintained blockchain backup parameters 107), such as a particular set of blockchain backup parameters 107 that is associated with a time that is closest to a time at which a blockchain restoration condition is identified. For example, assume that a first set of blockchain backup parameters 107 is associated with a timestamp of 1:00, that a second set of blockchain backup parameters 107 is associated with a timestamp of 2:00, and that a third set of blockchain backup parameters 107 is associated with a time stamp of 3:00. Further assume that a blockchain restoration condition is identified, based on which BBRS 105 determines that a malicious access occurred at 1:30.

In some embodiments, BBRS 105 may determine that the first set of blockchain backup parameters 107 should be selected, as the first set of blockchain backup parameters 107 is associated with a time that is closest to, without being later than, the time at which the malicious access was identified. In some embodiments, BBRS 105 may determine that the second set of blockchain backup parameters 107 should be selected, as the second set of blockchain backup parameters 107 is associated with a time that is closest to, without being earlier than, the time at which the malicious access was identified.

Process 800 may also include instructing (at 808) blockchain network 103 to perform a restoration operation based on the identified particular set of blockchain backup parameters 107. For example, BBRS 105 may provide the particular set of blockchain backup parameters 107, and/or may provide a link, URL, reference, etc. to some or all of the particular set of blockchain backup parameters 107. As discussed above, blockchain network 103 may participate in a consensus mechanism to determine whether to approve, validate, etc. the instruction to perform the restoration. On the other hand, in some embodiments, blockchain network 103 may approve, validate, etc. the instruction without performing a consensus mechanism.

Performing the restoration operation may include replacing current node configurations and blockchain state information, maintained by some or all of the nodes of blockchain network 103, with node configuration information 109 and blockchain state information 111 indicated in the provided set of blockchain backup parameters 107. For example, replacing a current node configuration with the node configuration information 109 provided as part of the set of blockchain backup parameters 107 may amount to a “rollback” of the current node configuration with the node configuration information 109 provided as part of the set of blockchain backup parameters 107. Similarly, replacing current blockchain state information with the blockchain state information 111 provided as part of the set of blockchain backup parameters 107 may amount to a “rollback” of the current blockchain state information with the blockchain state information 111 provided as part of the set of blockchain backup parameters 107.

Once all nodes of blockchain network 103 have implemented the restoration, blockchain 101 may be considered as fully restored or “rolled back” to the state it was in as of the time of the creation of the particular set of blockchain backup parameters 107. Rolling back node configuration information 109 along with blockchain state information 111 may ensure that incompatibilities or inconsistencies (e.g., with respect to chaincode that references information recorded to blockchain 101) do not arise, and that operation of blockchain 101 continues smoothly.

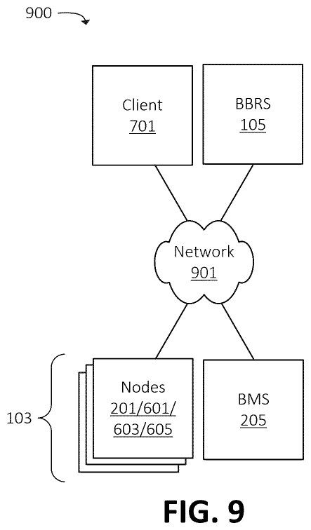

FIG. 9 illustrates an example environment 900, in which one or more embodiments may be implemented. Environment 900 may include network 901, BBRS 105, client 701, BMS 205, and nodes of blockchain network 103 (e.g., nodes 201, 601, 603, 605, etc.). In some embodiments, environment 900 may include one or more additional devices or systems communicatively coupled to network 901 and/or one or more other networks.

The quantity of devices and/or networks, illustrated in FIG. 9, is provided for explanatory purposes only. In practice, environment 900 may include additional devices and/or networks, fewer devices and/or networks, different devices and/or networks, or differently arranged devices and/or networks than illustrated in FIG. 9. For example, while not shown, environment 900 may include devices that facilitate or enable communication between various components shown in environment 900, such as routers, modems, gateways, switches, hubs, etc. In some implementations, one or more devices of environment 900 may be physically integrated in, and/or may be physically attached to, one or more other devices of environment 900. Alternatively, or additionally, one or more of the devices of environment 900 may perform one or more network functions described as being performed by another one or more of the devices of environment 900. Elements of environment 900 may interconnect with each other and/or other devices via wired connections, wireless connections, or a combination of wired and wireless connections. Some or all of the elements of environment 900 may be implemented by one or more devices, sets of hardware resources, cloud systems, or the like.

Network 901 may include one or more wired and/or wireless networks. For example, network 901 may include an IP-based Packet Data Network (“PDN”), a wide area network (“WAN”) such as the Internet, a private enterprise network, and/or one or more other networks. Client 701, BMS 205, nodes $1no, and/or other devices or systems may communicate, through network 901, with each other and/or with other devices that are coupled to network 901. Network 901 may be connected to one or more other networks, such as a public switched telephone network (“PSTN”), a public land mobile network (“PLMN”), and/or another network. Network 901 may be connected to one or more devices, such as content providers, applications, web servers, and/or other devices, with which client 701, BMS 205, nodes $1no, and/or other devices or systems may communicate.

BBRS 105, client 701, BMS 205, nodes of blockchain network 103 (e.g., nodes 201, peer nodes 601, ordering nodes 603, CA nodes 605, etc.), and/or other devices or systems may be implemented by one or more cloud systems, server devices, or other types of hardware resources. In some embodiments, BBRS 105, client 701, BMS 205, nodes of blockchain network 103, etc. may be implemented by or communicatively coupled to a User Equipment (“UE”), which may include a computation and communication device, such as a wireless mobile communication device that is capable of communicating with network 901. The UE may communicate with network 901 via a wired or a wireless interface, such as via one or more radio access network (“RANs”), such as a Fifth Generation (“5G”) RAN, a Long-Term Evolution (“LTE”) RAN, etc. The UE may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, a wearable device, a Machine-to-Machine (“M2M”) device, or the like), a Fixed Wireless Access (“FWA”) device, or another type of mobile computation and communication device.

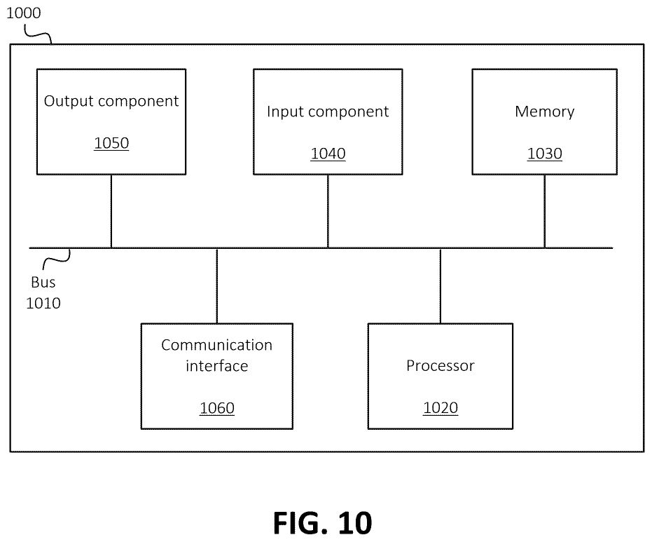

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems (e.g., via RAN $a10, RAN $a12, DN $a50, etc.). For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-8), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
maintain a set of backup parameters associated with a blockchain that is maintained by a plurality of nodes of a blockchain network, wherein the set of backup parameters is associated with a first time, wherein the set of backup parameters include:
first node configuration information of one or more nodes of the plurality of nodes at the first time, and
first blockchain state information at the first time;
identify, at a second time that is later than the first time, that the blockchain should be restored using the set of backup parameters associated with the first time; and
output, to the blockchain network, a restoration instruction that indicates the set of backup parameters associated with the first time, wherein based on the restoration instruction, the blockchain network:
replaces second node configuration information of the one or more nodes, associated with the second time, with the first node configuration information associated with the first time, and
replaces second blockchain state information, associated with the second time, with the first blockchain state information associated with the first time.

2. The device of claim 1, wherein the first blockchain state information includes a plurality of records that have been recorded to the blockchain prior to the first time.

3. The device of claim 2, wherein the second blockchain state information includes the plurality of records and at least one record that has been recorded to the blockchain after the first time.

4. The device of claim 1, wherein the first time is denoted by a first quantity of records that have been recorded to the blockchain prior to the first time, and wherein the second time is denoted by a second quantity of records that have been recorded to the blockchain prior to the second time, wherein the second quantity is greater than the first quantity.

5. The device of claim 1, wherein the plurality of nodes include a plurality of types of nodes, wherein the first node configuration information includes at least:
a first type of node configuration information associated with a first type of node of the plurality of types of nodes, and
a second type of node configuration information associated with a second type of node of the plurality of types of nodes.

6. The device of claim 5, wherein the first type of node includes a peer node, and wherein the second type of node includes an ordering node.

7. The device of claim 1, wherein the blockchain network participates in a consensus mechanism to determine whether to perform a restoration operation based on the restoration instruction, wherein replacing the second node configuration information and the second blockchain state information is performed in response to determining, based on the consensus mechanism, that the restoration operation should be performed.

8. A non-transitory computer-readable medium, storing a plurality of processor-executable instructions to:
maintain a set of backup parameters associated with a blockchain that is maintained by a plurality of nodes of a blockchain network, wherein the set of backup parameters is associated with a first time, wherein the set of backup parameters include:
first node configuration information of one or more nodes of the plurality of nodes at the first time, and
first blockchain state information at the first time;
identify, at a second time that is later than the first time, that the blockchain should be restored using the set of backup parameters associated with the first time; and
output, to the blockchain network, a restoration instruction that indicates the set of backup parameters associated with the first time, wherein based on the restoration instruction, the blockchain network:
replaces second node configuration information of the one or more nodes, associated with the second time, with the first node configuration information associated with the first time, and
replaces second blockchain state information, associated with the second time, with the first blockchain state information associated with the first time.

9. The non-transitory computer-readable medium of claim 8, wherein the first blockchain state information includes a plurality of records that have been recorded to the blockchain prior to the first time.

10. The non-transitory computer-readable medium of claim 9, wherein the second blockchain state information includes the plurality of records and at least one record that has been recorded to the blockchain after the first time.

11. The non-transitory computer-readable medium of claim 8, wherein the first time is denoted by a first quantity of records that have been recorded to the blockchain prior to the first time, and wherein the second time is denoted by a second quantity of records that have been recorded to the blockchain prior to the second time, wherein the second quantity is greater than the first quantity.

12. The non-transitory computer-readable medium of claim 8, wherein the plurality of nodes include a plurality of types of nodes, wherein the first node configuration information includes at least:
a first type of node configuration information associated with a first type of node of the plurality of types of nodes, and
a second type of node configuration information associated with a second type of node of the plurality of types of nodes.

13. The non-transitory computer-readable medium of claim 12, wherein the first type of node includes a peer node, and wherein the second type of node includes an ordering node.

14. The non-transitory computer-readable medium of claim 8, wherein the blockchain network participates in a consensus mechanism to determine whether to perform a restoration operation based on the restoration instruction, wherein replacing the second node configuration information and the second blockchain state information is performed in response to determining, based on the consensus mechanism, that the restoration operation should be performed.

15. A method, comprising:
maintaining a set of backup parameters associated with a blockchain that is maintained by a plurality of nodes of a blockchain network, wherein the set of backup parameters is associated with a first time, wherein the set of backup parameters include:
first node configuration information of one or more nodes of the plurality of nodes at the first time, and
first blockchain state information at the first time;
identifying, at a second time that is later than the first time, that the blockchain should be restored using the set of backup parameters associated with the first time; and
outputting, to the blockchain network, a restoration instruction that indicates the set of backup parameters associated with the first time, wherein based on the restoration instruction, the blockchain network:
replaces second node configuration information of the one or more nodes, associated with the second time, with the first node configuration information associated with the first time, and
replaces second blockchain state information, associated with the second time, with the first blockchain state information associated with the first time.

16. The method of claim 15, wherein the first blockchain state information includes a plurality of records that have been recorded to the blockchain prior to the first time.

17. The method of claim 16, wherein the second blockchain state information includes the plurality of records and at least one record that has been recorded to the blockchain after the first time.

18. The method of claim 15, wherein the first time is denoted by a first quantity of records that have been recorded to the blockchain prior to the first time, and wherein the second time is denoted by a second quantity of records that have been recorded to the blockchain prior to the second time, wherein the second quantity is greater than the first quantity.

19. The method of claim 15, wherein the plurality of nodes include a plurality of types of nodes, wherein the plurality of types include a peer node type and an ordering node type, wherein the first node configuration information includes at least:
a first type of node configuration information associated with a peer node type, and
a second type of node configuration information associated with an ordering node type.

20. The method of claim 15, wherein the blockchain network participates in a consensus mechanism to determine whether to perform a restoration operation based on the restoration instruction, wherein replacing the second node configuration information and the second blockchain state information is performed in response to determining, based on the consensus mechanism, that the restoration operation should be performed.
